(19) United States
(12) Patent Application Publication
(10) Pub. No.: US 2026/0299740 A1
(43) Pub. Date: Oct. 1, 2026

(54) TOUCH ELECTRODE UNIT AND STRUCTURE, AND DISPLAY PANEL

(71) Applicants: Chengdu BOE Optoelectronics Technology Co., Ltd., Chengdu, Sichuan (CN); BOE Technology Group Co., Ltd., Beijing (CN)

(72) Inventors: Yu WANG, Beijing (CN); Siyu WANG, Beijing (CN); Jianghua LIU, Beijing (CN); Tianci CHEN, Beijing (CN); Chang LUO, Beijing (CN); Ping WEN, Beijing (CN)

(21) Appl. No.: 19/479,290

(22) PCT Filed: Sep. 5, 2024
(86) PCT No.: PCT/CN2024/117272

§ 371 Date: Oct. 27, 2025

(30) Foreign Application Priority Data
Nov. 28, 2023 (CN) 202311607015.X

(51) Int. Cl. G06F 3/044

(52) U.S. Cl. CPC G06F 3/0448; G06F 3/0446; G06F 2203/04111

(57) ABSTRACT

The present application belongs to the technical field of display devices. Disclosed are a touch-control electrode unit, a touch-control electrode structure and a display panel. The touch-control electrode unit is defined as an incomplete state, and the touch-control electrode unit comprises a first touch-control electrode and a second touch-control electrode, the first touch-control electrode comprising a main body portion and an incomplete portion, which are separated by part of the second touch-control electrode, wherein the first touch-control electrode further comprises a first connecting portion, and the first connecting portion and the second touch-control electrode are arranged in a crossed manner, so as to be respectively connected to the main body portion and the incomplete portion.

### CROSS-REFERENCE TO RELATED APPLICATION

This application is a U.S. national stage of international application No. PCT/CN2024/117272, filed on Sep. 5, 2024, which claims priority to Chinese Patent Application No. 20231607015.X filed on Nov. 28, 2023 and entitled “TOUCH ELECTRODE UNIT AND STRUCTURE, AND DISPLAY PANEL”, the entire content of which is incorporated herein by reference.

### TECHNICAL FIELD

The present disclosure relates to the field of display device technologies, and in particular relates to a touch electrode unit and structure, and a display panel.

### BACKGROUND

The display panels with touch control function are widely used in various electronic devices. The touch pattern has a significant impact on touch sensitivity. Currently, due to the irregular shape of display panels, the touch pattern is incomplete at the edges of the display panel, affecting touch performance.

### SUMMARY

The present disclosure provides a touch electrode unit and structure, and a display panel.

According to some embodiments of the present disclosure, a touch electrode is provided unit, wherein the touch electrode unit is a touch electrode unit a touch pattern of which is an incomplete touch pattern formed by a complete touch pattern with at least one portion being removed, the touch electrode unit includes a first touch electrode and a second touch electrode, the first touch electrode includes a main portion having a complete partial touch pattern and an incomplete portion having an incomplete touch pattern, and the main portion and the incomplete portion are separated by at least one portion of the second touch electrode;
wherein the first touch electrode further includes a first connecting portion, the first connecting portion, the main portion, the incomplete portion, and the second touch electrode are arranged on a same layer, the first connecting portion and the second touch electrode are spaced apart from each other, and the first connecting portion is connected to the main portion and the incomplete portion.

In some embodiments, the first connecting portion has a rectilinear shape.

In some embodiments, the first connecting portion passes through the at least one portion of the second touch electrode that separates the main portion and the incomplete portion.

In some embodiments, the first connecting portion is arranged around one end of the at least one portion of the second touch electrode that separates the main portion and the incomplete portion.

In some embodiments, the first touch electrode includes a plurality of incomplete portions and a plurality of first connecting portions connected to the incomplete portions in one-to-one correspondence.

In some embodiments, the first touch electrode and the second touch electrode are in form of a grid, and the first connecting portion includes at least two grid lines.

In some embodiments, the at least one portion of the second touch electrode that separates the main portion and the incomplete portion is spaced apart from the first connecting portion by at least one grid line.

In some embodiments, the main portion of the first touch electrode includes a central portion and a peripheral portion, the second touch electrode is arranged around the central portion, and the peripheral portion and the incomplete portion are arranged around the second touch electrode.

According to some embodiments of the present disclosure, a touch electrode structure is provided, including a first touch electrode unit, a second touch electrode unit, and a second connecting portion, wherein the first touch electrode unit includes a first touch electrode and a second touch electrode, both of which have incomplete touch patterns formed by complete touch patterns with at least one portion being removed, and the second touch electrode unit includes a first touch electrode and a second touch electrode, both of which have complete touch patterns, the first touch electrode of the first touch electrode unit is connected to the first touch electrode of the second touch electrode unit, and the second connecting portion is arranged to connect the second touch electrode of the first touch electrode unit and the second touch electrode of the second touch electrode unit.

In some embodiments, an area of the first touch electrode unit is smaller than one-half of an area of the second touch electrode unit.

According to some embodiments of the present disclosure, a display panel is provided, including a backplane, a light-emitting layer, an encapsulation layer, and a touch layer which are stacked, wherein the touch layer includes a first touch layer, a touch insulation layer, and a second touch layer; the touch layer defines at least one touch electrode unit according to at least one of the above embodiments, the touch electrode unit is arranged on the second touch layer, and a bridge electrode for connecting different touch electrode units is arranged on the first touch layer.

In some embodiments, the touch electrode unit is disposed at an edge of the display panel, and the edge of the display panel includes a perforated edge of a display region and a peripheral edge of the display region.

According to some embodiments of the present disclosure, a display panel is provided, including a backplane, a light-emitting layer, an encapsulation layer, and a touch layer which are stacked, wherein the touch layer includes a first touch layer, a touch insulation layer, and a second touch layer; the touch layer defines at least one touch electrode structure according to at least one of the above embodiments, the first touch electrode, the second touch electrode, and the connecting portion of the touch electrode structure are arranged on the second touch layer, and the bridge electrode configured to connect different touch electrode units is arranged on the first touch layer.

In some embodiments, the touch electrode structure is disposed at an edge of the display panel, and the edge of the display panel includes a perforated edge of a display region and a peripheral edge of the display region.

Additional aspects and advantages of the present disclosure are to be given in part in the description below, and become obvious in part from the description below, or are learned through practice of the present disclosure.

### BRIEF DESCRIPTION OF DRAWINGS

The above and/or additional aspects and advantages of the present disclosure will become apparent and easily understood from the description of the embodiments in conjunction with the following drawings. In the drawings:

FIG. 1 is a schematic structural diagram of a touch electrode unit in a complete state according to some embodiments of the present disclosure;

FIG. 2 is a first structural schematic diagram of a touch electrode unit in an incomplete state according to some embodiments of the present disclosure;

FIG. 3 is a second structural diagram of a touch electrode unit in an incomplete state according to some embodiments of the present disclosure;

FIG. 4 is a third structural diagram of a touch electrode unit in an incomplete state according to some embodiments of the present disclosure;

FIG. 5 is a fourth structural diagram of a touch electrode unit in an incomplete state according to some embodiments of the present disclosure;

FIG. 6 is a schematic structural diagram of a touch electrode structure according to some embodiments of the present disclosure; and

FIG. 7 is a schematic structural diagram of a display panel according to some embodiments of the present disclosure.

### DETAILED DESCRIPTION

Embodiments of the present disclosure are described in detail below, with examples of the embodiments illustrated in the accompanying drawings. In the accompanying drawings, the sizes of layers, regions, and components, as well as their relative sizes, may be exaggerated for clarity. Throughout, the same or similar reference numerals represent the same or similar components or components having the same or similar functions. The embodiments described below with reference to the accompanying drawings are illustrative and intended only to explain the present disclosure, and are not to be construed as limiting the present disclosure.

It should be understood that when an element or layer is referred to as being “on,” “adjacent to,” “connected to,” or “coupled to” another element or layer, it can be directly on, adjacent to, connected to, or coupled to the other element or layer, or there can be intervening elements or layers. Conversely, when an element is referred to as being “directly on,” “directly adjacent to,” “directly connected to,” or “directly coupled to” another element or layer, there are no intervening elements or layers. It should be understood that while the terms first, second, third, etc. may be configured to describe various elements, components, regions, layers, and/or parts, these elements, components, regions, layers, and/or parts should not be limited by these terms. These terms are merely configured to distinguish one element, component, region, layer, or part from another. Thus, without departing from the teachings of the present disclosure, a first element, component, region, layer, or part discussed below may be represented as a second element, component, region, layer, or part. Furthermore, when a second element, component, region, layer, or part is discussed, it does not necessarily mean that the first element, component, region, layer, or part is present in the present disclosure.

Throughout this specification, reference to terms such as “one embodiment,” “some embodiments,” “illustrative embodiments,” “examples,” “specific examples,” or “some examples” means that the specific features, structures, materials, or characteristics described in conjunction with the embodiment or example are included in at least one embodiment or example of the present disclosure. In this specification, the illustrative expressions of the above terms do not necessarily refer to the same embodiment or example. Moreover, the specific features, structures, materials, or characteristics described may be combined in any suitable manner in any one or more embodiments or examples.

In the field of display, OLED (organic light-emitting diode) displays are considered an emerging technology for the next generation of flat-panel displays due to their superior properties. On-cell touch design is a current trend in OLED manufacturing, offering particular advantages in foldable products. On-cell refers to embedding the touch structure between the color filter substrate and polarizer of the display panel. This method achieves mutual-capacitive touch electrode structure.

The mutual capacitance touch electrode structure includes touch drive electrodes and touch sensing electrodes, which form a mutual capacitance for touch sensing. The touch drive electrodes are configured to input excitation signals (touch drive signals), and the touch sensing electrodes are configured to output touch sensing signals. By inputting excitation signals to, for example, vertically extending touch drive electrodes and receiving touch sensing signals from, for example, horizontally extending touch sensing electrodes, the capacitance value of the coupling point (e.g., intersection) between the horizontal and vertical electrodes can be determined. In the case that a finger touches the capacitive screen, it affects the coupling between the touch drive electrode and the touch sensing electrode near the touch point, thereby changing the capacitance between the two electrodes. Based on the two-dimensional capacitance change data of the touch screen, the coordinates of each touch point (intersection) are calculated.

However, in current touchscreen designs, due to the limitations of display panel geometry, the apertures in the edges of display panels or display region are typically curved, while the edges of each cell in the touchscreen pattern are typically straight lines, and the touchscreen pattern is incomplete at the edges. Furthermore, within this incomplete pattern, the pattern for the desired access channel signal is also incomplete. The degree of this incompleteness is significantly affected by the pattern's internal design and layout. Active pen patterns are particularly complex, making internal design optimization essential.

The present disclosure proposes a touch electrode unit and structure, and a display panel, which connect the divided patterns, thereby reducing the patterns that are not connected to the touch signal channel, ensuring that the touch patterns that are connected to the communication signal are sufficient, and guaranteeing the touch effect.

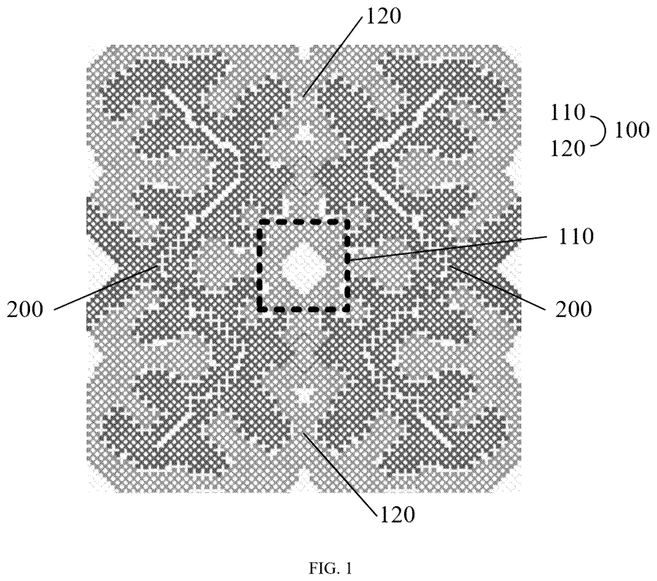

Referring to FIG. 1, a touch electrode unit in a complete state is shown. The touch electrode unit includes a first touch electrode 100 and a second touch electrode 200. The first touch electrode 100 is a touch drive electrode, and the second touch electrode 200 is a touch sensing electrode. Alternatively, the first touch electrode 100 is a touch sensing electrode, and the second touch electrode 200 is a touch drive electrode.

The first touch electrode 100 includes a central portion 110 and a peripheral portion 120. In this pattern, the central portion 110 is disposed at the center of the pattern. The central portion 110 extends upward and downward to form the peripheral portion 120. The peripheral portion 120 includes a first portion extending above the central portion 110 and a second portion extending below the central portion 110. A plurality of first interdigital portions are formed on the central portion 110 and the peripheral portion 120. These first interdigital portions interleave with second interdigital portions on the second touch electrode 200 to increase the facing area.

The second touch electrode 200 includes a third portion and a fourth portion that are symmetrical. The third and fourth portions are curved and have a plurality of second interdigitated portions, with adjacent fold lines positioned at 90-degree angles. The third and fourth portions are arranged on the left and right sides of the central portion 110 respectively, to surround the central portion 110. The third and fourth portions form bridges above and below the central portion 110 respectively, and the bridges connect the third and fourth portions. The peripheral portion 120 extends outward from the bridges and extends to both sides to surround the third and fourth portions of the second touch electrode 200.

As can be seen, the width of the portion of the peripheral portion 120 surrounding the second touch electrode 200 is relatively small, and in the case that the touch electrode unit is arranged on the curved edge, the peripheral portion 120 is easily cut off. The cut peripheral portion 120 is not connected to the central portion 110 and cannot perform the touch detection function.

The following describes various embodiments of the present disclosure with reference to the touch electrode unit shown in FIG. 1, and the touch electrode unit is also in other shapes, which is not limited in the embodiments.

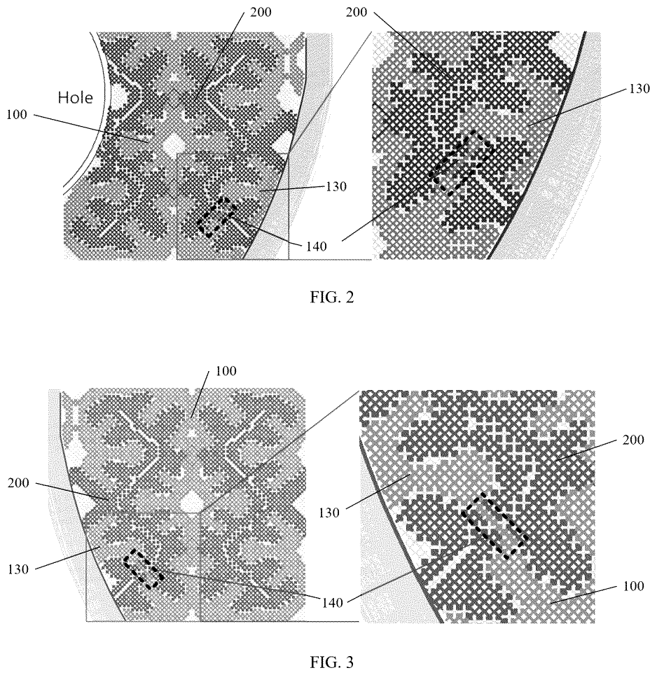

Referring to FIG. 2, a touch electrode unit in an incomplete state is shown. The embodiments of the present disclosure provide a touch electrode unit, which is defined as being in an incomplete state, and includes a first touch electrode 100 and a second touch electrode 200. The first touch electrode 100 includes a main portion and an incomplete portion 130. The main portion and the incomplete portion 130 are separated by a portion of the second touch electrode 200. The first touch electrode 100 also includes a first connecting portion 140. The first connecting portion 140, the main portion, the incomplete portion 130, and the second touch electrode 200 are arranged on a same layer. The first connecting portion 140 is spaced apart from the second touch electrode 200 and connected to the main portion and the incomplete portion 130.

A display panel is provided with a plurality of repeatedly arranged touch electrode units. The touch electrode units at positions away from the edge of the display panel are usually in a complete state. The electrodes in such complete touch electrode units are the same as the designed touch pattern, as shown in FIG. 1. In the case that the touch electrode units are arranged close to the edge of the display panel, in order to adapt to the shape of the edge, the portion exceeding the edge is removed, thereby being defined as an incomplete state. Compared with the designed touch pattern, some electrodes in such incomplete touch electrode units are incomplete part of the pattern. The edge of the display panel is a perforated edge of the display region and a peripheral edge of the display region.

In addition, the spacing between the perforated edge of the display region and the peripheral edge of the display region in some display panels is small, and the touch electrode units arranged between the perforated edge of the display region and the peripheral edge of the display region are also in an incomplete state. As shown in FIG. 1, the left side of the touch electrode unit is the perforated edge of the display region, and the right side of the touch electrode unit is the peripheral edge of the display region.

Compared with the complete state, the first touch electrode 100 and the second touch electrode 200 in the touch electrode unit in the incomplete state are both incomplete. The first touch electrode 100 disposed at the outermost periphery is prone to have a discontinuous main portion and incomplete portion 130 due to partial incompleteness.

The main portion of the first touch electrode 100 includes a central portion 110 and an undivided peripheral portion 120. The incomplete portion 130 is formed by the divided peripheral portion 120. Comparing FIGS. 1 and 2, the lower right portion of the touch electrode unit in the embodiment is incomplete. The main portion and the incomplete portion 130 are separated by a portion of the second touch electrode 200 (hereinafter referred to as a spacing portion).

It should be noted that the first connecting portion 140, the main portion, the incomplete portion 130, and the second touch electrode 200 are arranged on the same layer. In the incomplete state, the space occupied by the spacing portion of the second touch electrode 200 is configured as the first connecting portion 140. The two ends of the first connecting portion 140 are respectively connected to the main portion and the incomplete portion 130, thereby reconnecting the incomplete portion 130 to the main portion and allowing it to be used again for touch detection.

According to the touch electrode unit of the present disclosure, a connecting portion is provided in the incomplete first touch electrode 100 to connect the divided main portion and the incomplete portion, thereby reducing the pattern that is not connected to the touch signal channel, ensuring that the touch pattern that is connected to the communication signal is sufficient, and guaranteeing the touch effect.

In some embodiments, the first connecting portions 140 are arranged along a straight line.

The rectilinear shape of the first connecting portion 140 can shorten the length of the first connecting portion 140. In addition, the first connecting portion 140 is connected to the position where the main portion and the incomplete portion 130 are closest to each other, which can shorten the length of the first connecting portion 140 and reduce the signal transmission distance.

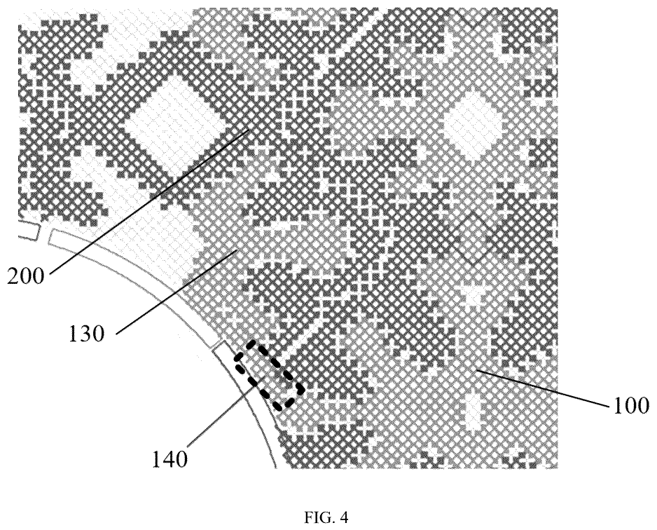

Referring to FIGS. 2 and 3, FIG. 3 also shows a touch electrode unit in an incomplete state. In some embodiments, the first connecting portion 140 is arranged to pass through the portion of the second touch electrode 200 that separates the main portion and the incomplete portion 130.

In the embodiments, the extension direction of the first connecting portion 140 is perpendicular to the extension direction of the spacing portion of the second touch electrode 200. The first connecting portion 140 passes through the middle of the spacing portion to connect the main portion and the incomplete portion 130 on both sides of the spacing portion.

It should be noted that touch signal lines are usually provided at the peripheral edge of the display region, and these touch signal lines are connected to the second touch electrodes 200. Therefore, even though the first connecting portion 140 passes through the spacing portion, dividing the spacing portion into two separate portions, the spacing portion near the edge can still transmit signals through the touch signal lines, and the touch function can still be realized.

Referring to FIG. 4, FIG. 4 also shows a touch electrode unit in an incomplete state. In some embodiments, the first connecting portion 140 is arranged around the end of the portion of the second touch electrode 200 that separates the main portion and the incomplete portion 130.

In the embodiments, the extension direction of the first connecting portion 140 is perpendicular to the extension direction of the spacing portion of the second touch electrode 200. The first connecting portion 140 is arranged at the end of the spacing portion to connect the main portion and the incomplete portion 130 on both sides of the spacing portion.

Because the first connecting portion 140 does not pass through the middle of the spacing portion, the spacing portion is not divided. In the case where one end of the second touch electrode 200 near the edge of the display region is not connected to the touch signal line, the first connecting portion 140 does not cause additional incomplete patterns around the end of the spacing portion.

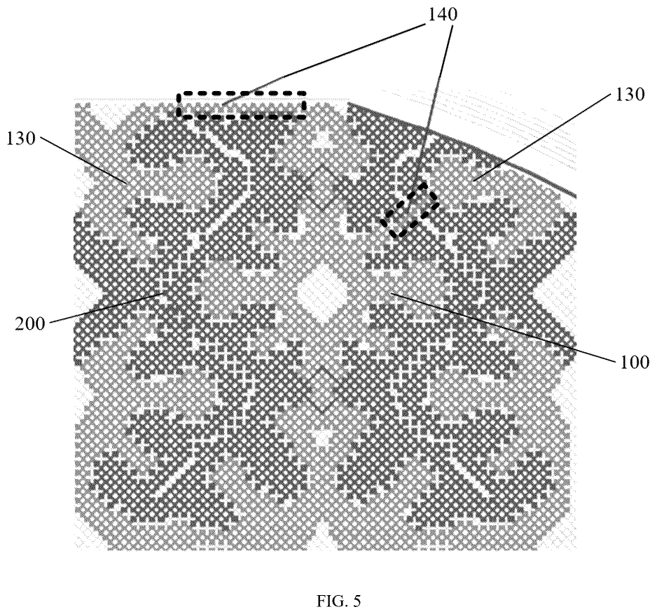

Referring to FIG. 5, FIG. 5 also shows a touch electrode unit in an incomplete state. In some embodiments, the first touch electrode 100 includes a plurality of incomplete portions 130 and a plurality of first connecting portions 140 connected to the incomplete portions 130 in one-to-one correspondence.

In the embodiments, the touch electrode units are arranged at a plurality of edges, such as the intersection of two adjacent edges of the display region. Because the touch electrode units need to adapt to a plurality of edges, a plurality of incomplete portions 130 are present. In this case, the touch electrode units need to be provided with a plurality of first connecting portions 140 to connect each incomplete portion 130 to the main portion.

As an example, some of the first connecting portions 140 in the first touch electrode 100 are arranged to pass through the middle of the spacing portion of the second touch electrode 200, and other parts are arranged around the ends of the spacing portion of the second touch electrode 200.

In some embodiments, the first touch electrodes 100 and the second touch electrodes 200 are in form of a grid, and the first connecting portion 140 includes at least two grid lines.

It should be noted that because the touch structure is arranged above the pixel array, to prevent the touch electrode wiring from affecting the pixel light transmittance, the touch electrode wiring is arranged between the pixels. The resulting touch electrode has a grid pattern. The grid area is the pixel area, and the grid lines are arranged between the pixels. Typically, the grid line width is about 3 mm.

The first touch electrode 100 and the second touch electrode 200 include a plurality of grid lines, and their coverage range is designed according to the touch pattern, which is not limited in the embodiments.

In the embodiments, the first connecting portion 140 includes at least two grid lines, which can ensure reliable transmission of touch signals. The two grid lines are arranged adjacent to each other or spaced apart.

In some embodiments, the first connecting portion 140 is spaced apart from the portion of the second touch electrode 200 that separates the main portion and the remaining portion 130 by at least one grid line.

In the embodiments, the first connecting portion 140 is spaced apart from the portion facing the spacing portion of the second touch electrode 200 by at least one grid line, that is, at least the width of two pixels. This reduces the coupling between the first touch electrode 100 and the second touch electrode 200.

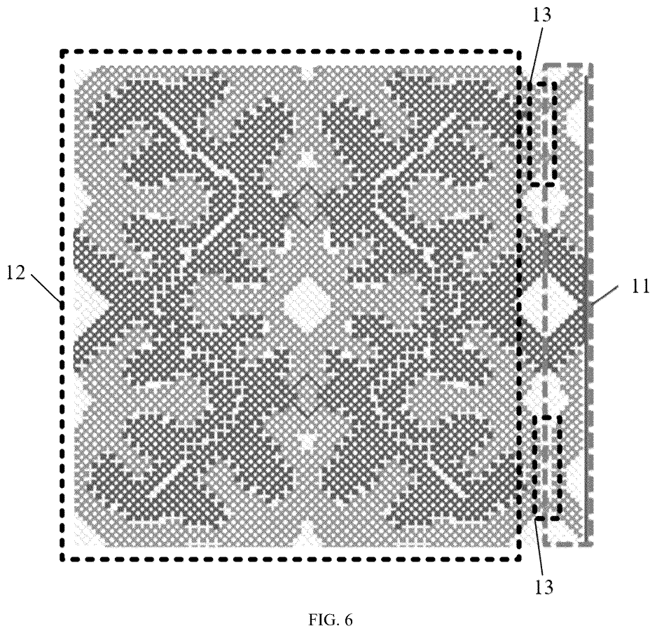

Referring to FIG. 6, FIG. 6 shows a touch electrode structure. An embodiment of the present disclosure further provides a touch electrode structure.

In the embodiments, the touch electrode structure includes a first touch electrode unit 11, a second touch electrode unit 12, and a second connecting portion 13. The first touch electrode unit 11 includes a first touch electrode and a second touch electrode, both of which are in an incomplete state. The second touch electrode unit 12 includes a first touch electrode and a second touch electrode, both of which are in a complete state. The first touch electrode in the incomplete state of the first touch electrode unit 11 is connected to the first touch electrode in the complete state of the second touch electrode unit 12. The second connecting portion 13 is arranged to connect the second touch electrode in the incomplete state of the first touch electrode unit 11 and the second touch electrode in the complete state of the second touch electrode unit 12.

In the embodiments, the first touch electrode unit 11 is in an incomplete state, and the second touch electrode unit 12 is in a complete state. Both touch electrode units include a first touch electrode and a second touch electrode. The first touch electrode refers to a touch drive electrode, and the second touch electrode refers to a touch sensing electrode. Alternatively, the first touch electrode refers to a touch sensing electrode, and the second touch electrode refers to a touch drive electrode. Usually, in the case that the touch electrode units are arranged normally, only a corresponding set of electrodes are connected to each other in a certain direction. For example, in the row direction, the touch drive electrodes of two adjacent touch electrode units are connected, or, in the column direction, the touch sensing electrodes of two adjacent touch electrode units are connected. In the embodiments, the second connecting portion 13 is configured to connect a set of electrodes that are not connected in the case that the touch electrode units are arranged normally. For example, in the case that the first touch electrode unit 11 and the second touch electrode unit 12 are arranged along the row direction, the second connecting portion 13 connects the touch sensing electrodes in the two touch electrode units, or in the case that the first touch electrode unit 11 and the second touch electrode unit 12 are arranged along the column direction, the second connecting portion 13 connects the touch driving electrodes of the two touch electrode units.

Continuing with FIG. 1, taking the touch electrode unit shown in FIG. 1 as an example, the first touch electrode unit 11 is in an incomplete state, in which the first touch electrode 100 and the second touch electrode 200 are in an incomplete state, and the first touch electrode 100 is not connected to other adjacent touch electrode units, and the first touch electrode 100 cannot perform normal actual touch detection.

The second touch electrode unit 12 is in a complete state. By connecting the first touch electrode 100 in the first touch electrode unit 11 to the first touch electrode 100 in the second touch electrode unit 12, the first touch electrode unit 11 can still realize the touch function.

According to the touch electrode structure of the present disclosure, by connecting the incomplete touch electrode unit to the adjacent touch electrode unit, the pattern that is not connected to the touch signal channel is reduced, ensuring that the touch pattern connected to the communication signal is sufficient, thereby ensuring the touch effect.

In some embodiments, the area of the first touch electrode unit 11 is smaller than one-half of the area of the second touch electrode unit 12.

It should be noted that in the case that the first touch electrode unit 11 has a minor defect, the solution of the aforementioned embodiment can be adopted, that is, the incomplete portion 130 in the first touch electrode 100 is connected to the main portion. However, in the case that the first touch electrode unit 11 has a major defect, the main portion of the first touch electrode 100 cannot achieve signal transmission. In this case, the incomplete portion of the first touch electrode 100 can be connected to the first touch electrode 100 in the adjacent touch electrode unit.

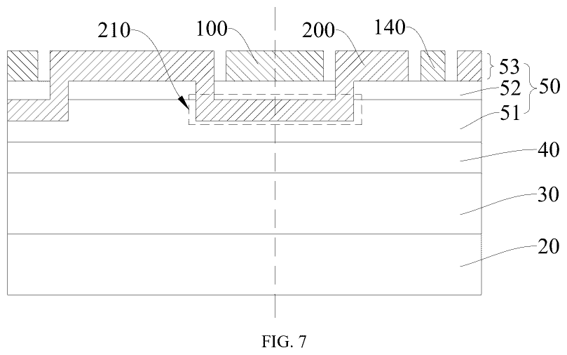

Referring to FIG. 7, an embodiment of the present disclosure further provides a display panel. The display panel includes a backplane 20, a light-emitting layer 30, an encapsulation layer 40, and a touch layer 50 which are stacked. The touch layer 50 includes a first touch layer 51, a touch insulating layer 52, and a second touch layer 53. The touch layer 50 defines the aforementioned touch electrode unit or the aforementioned touch electrode structure. The first touch electrode 100, the second touch electrode 200, and the connecting portion of the touch electrode unit or the touch electrode structure are disposed on the second touch layer 53, and the bridge electrode 210 is disposed on the first touch layer 51. For the specific structure and principles of the touch electrode unit and the touch electrode structure, reference is made to the aforementioned embodiments and is not further described in the embodiment.

As shown in FIG. 7, as an example, the left and right sides of the dashed line represent two touch electrode units, with bridge electrodes 210 configured to bridge the second touch electrodes 200 in the two touch electrode units. The touch electrode unit on the right is in an incomplete state, with a first connecting portion 140 disposed on the middle of the second touch electrode 200. The first connecting portion 140 connects the main portion and the incomplete portion 130 of the first touch electrode 100 within a touch electrode unit. The first touch electrode 100, the first connecting portion 140, and the second touch electrode 200 are arranged on a same layer.

According to the display panel of the present disclosure, the incomplete touch pattern divided at the edge can be connected to the touch signal channel, ensuring that the touch pattern connected to the communication signal is sufficient, thereby guaranteeing the touch effect.

Although the embodiments of the present disclosure have been shown and described, those skilled in the art will appreciate that various changes, modifications, substitutions, and variations is made to the embodiments without departing from the principles and intent of the present disclosure, and that the scope of the present disclosure is defined by the claims and their equivalents.

1. A touch electrode unit, wherein the touch electrode unit is a touch electrode unit, a touch pattern of which is an incomplete touch pattern formed by a complete touch pattern with at least one portion being removed, the touch electrode unit comprises a first touch electrode and a second touch electrode, the first touch electrode comprises a main portion having a complete touch pattern and an incomplete portion having an incomplete touch pattern, and the main portion and the incomplete portion are separated by at least one portion of the second touch electrode;
wherein the first touch electrode further comprises a first connecting portion, the first connecting portion, the main portion, the incomplete portion, and the second touch electrode are arranged on a same layer, the first connecting portion and the second touch electrode are spaced apart from each other, and the first connecting portion is connected to the main portion and the incomplete portion.

2. The touch electrode unit according to claim 1, wherein the first connecting portion has a rectilinear shape.

3. The touch electrode unit according to claim 2, wherein the first connecting portion passes through the at least one portion of the second touch electrode that separates the main portion and the incomplete portion.

4. The touch electrode unit according to claim 2, wherein the first connecting portion is arranged around one end of the at least one portion of the second touch electrode that separates the main portion and the incomplete portion.

5. The touch electrode unit according to claim 1, wherein the first touch electrode comprises a plurality of incomplete portions and a plurality of first connecting portions connected to the incomplete portions in one-to-one correspondence.

6. The touch electrode unit according to claim 1, wherein the first touch electrode and the second touch electrode are in form of a grid, and the first connecting portion comprises at least two grid lines.

7. The touch electrode unit according to claim 6, wherein the at least one portion of the second touch electrode that separates the main portion and the incomplete portion is spaced apart from the first connecting portion by at least one grid line.

8. The touch electrode unit according to claim 1, wherein the main portion of the first touch electrode comprises a central portion and a peripheral portion, the second touch electrode is arranged around the central portion, and the peripheral portion and the incomplete portion are arranged around the second touch electrode.

9. A touch electrode structure, comprising a first touch electrode unit, a second touch electrode unit, and a second connecting portion, wherein the first touch electrode unit comprises a first touch electrode and a second touch electrode, both of which have incomplete touch patterns formed by complete touch patterns with at least one portion being removed, and the second touch electrode unit comprises a first touch electrode and a second touch electrode, both of which have complete touch patterns, the first touch electrode of the first touch electrode unit is connected to the first touch electrode of the second touch electrode unit, and the second connecting portion is arranged to connect the second touch electrode of the first touch electrode unit and the second touch electrode of the second touch electrode unit.

10. The touch electrode structure according to claim 9, wherein an area of the first touch electrode unit is smaller than one-half of an area of the second touch electrode unit.

11. A display panel, comprising a backplane, a light-emitting layer, an encapsulation layer, and a touch layer which are stacked, wherein the touch layer comprises a first touch layer, a touch insulation layer, and a second touch layer; the touch layer defines at least one touch electrode unit, the touch electrode unit is arranged on the second touch layer, and a bridge electrode configured to connect different touch electrode units is arranged on the first touch layer;
wherein the touch electrode unit is a touch electrode unit, a touch pattern of which is an incomplete touch pattern formed by a complete touch pattern with at least one portion being removed, the touch electrode unit comprises a first touch electrode and a second touch electrode, the first touch electrode comprises a main portion having a complete touch pattern and an incomplete portion having an incomplete touch pattern, and the main portion and the incomplete portion are separated by at least one portion of the second touch electrode;
wherein the first touch electrode further comprises a first connecting portion, the first connecting portion, the main portion, the incomplete portion, and the second touch electrode are arranged on a same layer, the first connecting portion and the second touch electrode are spaced apart from each other, and the first connecting portion is connected to the main portion and the incomplete portion.

12. The display panel according to claim 11, wherein the touch electrode unit is disposed at an edge of the display panel, and the edge of the display panel comprises a perforated edge of a display region and a peripheral edge of the display region.

13. A display panel comprising a backplane, a light-emitting layer, an encapsulation layer, and a touch layer which are stacked, wherein the touch layer comprises a first touch layer, a touch insulation layer, and a second touch layer, the touch layer defines at least one touch electrode structure as defined in claim 9, the first touch electrode, the second touch electrode, and the connecting portion of the touch electrode structure are arranged on the second touch layer, and the bridge electrode configured to connect different touch electrode units is arranged on the first touch layer.

14. The display panel according to claim 13, wherein the touch electrode structure is disposed at an edge of the display panel, and the edge of the display panel comprises a perforated edge of a display region and a peripheral edge of the display region.

15. The display panel according to claim 11, wherein the first connecting portion has a rectilinear shape.

16. The display panel according to claim 15, wherein the first connecting portion passes through the at least one portion of the second touch electrode that separates the main portion and the incomplete portion.

17. The display panel according to claim 15, wherein the first connecting portion is arranged around one end of the at least one portion of the second touch electrode that separates the main portion and the incomplete portion.

18. The display panel according to claim 11, wherein the first touch electrode comprises a plurality of incomplete portions and a plurality of first connecting portions connected to the incomplete portions in one-to-one correspondence.

19. The display panel according to claim 11, wherein the first touch electrode and the second touch electrode are in form of a grid, and the first connecting portion comprises at least two grid lines.

20. The display panel according to claim 19, wherein the at least one portion of the second touch electrode that separates the main portion and the incomplete portion is spaced apart from the first connecting portion by at least one grid line.
